(19) United States
(12) Patent Application Publication
(10) Pub. No.: US 2014/0252686 A1
(43) Pub. Date: Sep. 11, 2014

(54) METHOD FOR DETECTING THE PRESENCE OF BUBBLES DURING OPERATIONS OF INJECTING RESIN FOR THE MANUFACTURE OF FIBRE COMPOSITE COMPONENTS

(71) Applicants: AIRCELLE, GONFREVILLE L'ORCHER (FR); CENTRE NATIONAL DE LA RECHERCHE SCIENTIFIQUE, Paris (FR)

(72) Inventors: Florent BOUILLON, ANGLESQUEVILLE L'ESNEVAL (FR); Joël BREARD, SAINT AUBIN SUR MER (FR); Laurent BIZET, ROUEN (FR); Sébastien GUEROULT, LE HAVRE (FR)

(73) Assignees: AIRCELLE, GONFREVILLE L'ORCHER (FR); CENTRE NATIONAL DE LA RECHERCHE SCIENTIFIQUE, Paris (FR)

(21) Appl. No.: 14/285,894

(22) Filed: May 23, 2014

Related U.S. Application Data
(63) Continuation of application No. PCT/FR2012/052614, filed on Nov. 13, 2012.

(30) Foreign Application Priority Data
Nov. 23, 2011 (FR) 11/03562

(51) Int. Cl. B29C 45/00

(52) U.S. Cl. CPC B29C 45/0025; B29K 2063/00
USPC 264/408; 425/169

(57) ABSTRACT

A method of detecting bubbles during operations for injecting resin for the manufacture of fibre composite components, is noteworthy in that the electrical capacitance or conductivity of at least one part of the medium formed by the fibres and the liquid is measured.

### CROSS-REFERENCE TO RELATED APPLICATIONS

This application is a continuation of International Application No. PCT/FR2012/052614, filed on Nov. 13, 2012 which claims the benefit of FR 11/03562, filed on Nov. 23, 2011. The disclosures of the above applications are incorporated herein by reference.

### FIELD

The present disclosure relates to a method for detecting the presence of bubbles and resin flow front during resin injection operations for manufacturing fiber composite parts.

### BACKGROUND

The statements in this section merely provide background information related to the present disclosure and may not constitute prior art.

The fiber composite parts comprise a network of fibers (carbon or glass, for example) embedded in a matrix of resin cured by heat polymerization.

The resin may be, for example, an organic resin (called organic matrix composite (OMC), epoxy resin, for example), a geopolymer resin, or a pre-ceramic resin.

Such parts are used in many industries, particularly in the aerospace industry, due to their excellent strength-to-weight ratio, and moderate manufacturing cost.

Among the various methods for manufacturing these fiber composite parts, are the injection type methods or LCM (liquid composite molding), and more particularly the RTM type (resin transfer molding) methods, consisting in injecting the resin under vacuum through the fiber tissues.

A common disadvantage related to these resin-injection-type methods is the appearance of air bubbles, resulting in competition between the capillary forces and the viscous forces.

The appearance of these bubbles causes the creation of vacuums in the final composite part which are likely to affect the strength and durability of this part.

Until now, the detection of these bubbles has been performed only at the end of the production line, through conventional non-destructive controls.

The disadvantage of such a posteriori detection is that it comes too late to allow for coercive actions to be carried out on the production line: when a very important bubble level is detected in a composite part thus produced, the only solution is to discard it.

This causes loss of time and materials which are very harmful to the overall economy of the process.

### SUMMARY

The present disclosure provides a method for detecting bubbles during resin injection operations for manufacturing fiber composite components, by means of a facility comprising:

at least one mould and one counter-mould,

at least one pair of electrodes disposed respectively in this mould and this counter-mould,

a source of alternating current input voltage connected to one of these electrodes,

an RC circuit connected firstly to one of these electrodes and secondly to the mass, at the ends of which an alternating current reference voltage is found, and

means for signal processing, adapted to exploit the measurements of said alternating current input voltage and alternating current reference voltage,

wherein the rate of bubbles included between said electrodes is calculated based on said measurements.

This method permits to know the rate of bubbles in the resin of the composite through electrical measurements which can be performed in a very simple way.

According to other features of this method:
a relatively high frequency is used for said source of alternating current input voltage, the capacitance of at least one portion of the area formed by fibers and the liquid resin is measured, and said rate of bubbles is deduced from a relationship of the type φᵥ=f (εᵥ, εᵣ, ε_{f}, and εₜ, φ_{f}, C_{cap}), where εᵥ, εᵣ, ε_{f}, and εₜ are respectively the permittivity constants of the vacuum, the resin, and the composite, and φᵥ, φᵣ, and φ_{f} are respectively the rates of bubbles, resin and fibers between the two electrodes: the capacitance of this area is in fact influenced by the presence of bubbles, so that the measurement of this capacitance allows for immediate corrections (resin injection pressure, etc.) necessary for the disappearance of these bubbles;
said capacitance measurement is used to derive the coefficients of depolarization of said bubbles, and thus the shapes and sizes of these bubbles;
a relatively low frequency is used for said source of alternating current input voltage, said alternating current reference voltage is compared to a voltage value representing the theoretical value if the resin flowing between said electrodes was totally free of bubbles, and said rate of bubbles is deduced from the proportionality factor between these two values.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 shows the electric diagram of the facility according to the present disclosure;

FIG. 2 shows two electrodes of the facility according to the present disclosure, with display of the edge effect parasitizing the measurements;

FIG. 3 shows the two electrodes of FIG. 2, to which two guard electrodes were added in order to minimize the edge effects; and

FIG. 4 shows the variation of the modulus of the alternating current reference voltage overtime, as well as the variation of the modulus of a theoretical alternating current maximum voltage, corresponding to a complete absence of bubbles in the area on which the measurements are performed (note that the measurement is a voltage whether the sensor operates in capacitive or conductive mode).

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

In all these figures, identical or similar references refer to identical or similar members or groups of members.

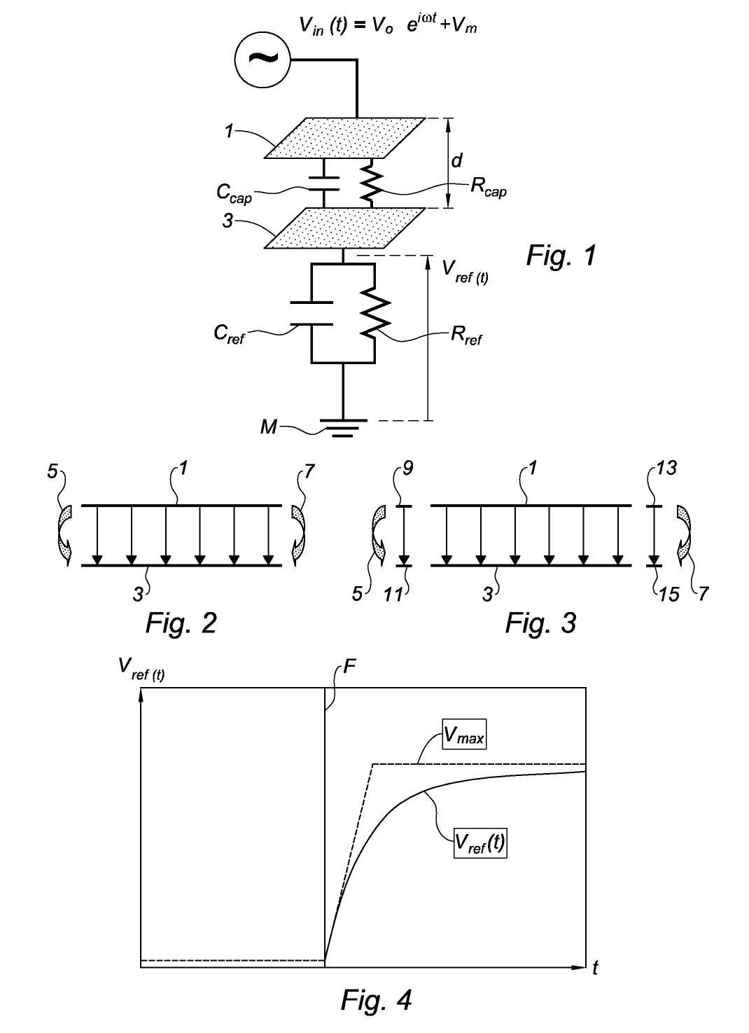

Referring now to FIG. 1, wherein two electrodes 1 and 3 are shown, intended to be integrated into the mould and counter-mould of an apparatus for manufacturing a part made of fiber composite by a liquid-resin-injection-type method (LCM method).

Such a method involves placing fiber fabrics, for example in carbon or in glass, between the mould and the counter-mould, and injecting a resin (epoxy, geopolymer, or pre-ceramic resin for example) in these fabrics: the resin impregnates the fiber fabrics by moving with a progression front.

When this front progression has cut across all fiber fabrics, the temperature may be raised so as to allow the resin to polymerize around the fibers.

As stated in the preamble of the present description, progression of the resin through the fibers is very often accompanied by the creation of air bubbles, which may subsequently generate porosity in the final part, which is not acceptable in terms of mechanical strength of the part.

The two electrodes 1 and 3 positioned on both sides of the area formed by the liquid resin and the fibers will make it possible to detect the presence of the bubbles before the resin polymerization step, as is clear from the following explanations.

An alternating current voltage Vᵢₙ(t) is applied to the electrode 1 and a reference voltage V_{ref}(t) is measured on the other electrode 3.

More specifically, the voltage V_{ref}(t) is tapped off an RC-type circuit comprising a resistor R_{ref} and a capacitor C_{ref}, this circuit being interposed between the mass M and the electrode 3.

The two electrodes 1 and 3 are separated by a distance substantially corresponding to the thickness of the part to be manufactured.

As can be seen in FIG. 1, the area formed by the resin and the fibers can itself be modeled as an RC-type circuit having its own resistance R_{cap} and its own capacitance C_{cap}.

The method according to the present disclosure consists in measuring the capacitance C_{cap}, which, we have come to realize, was indicative of the presence, quantity and shape of the air bubbles trapped in the resin.

Theoretical studies have shown that the presence, quantity, and shape of these air bubbles affect the permittivity of the area constituted by the resin and the fibers, and therefore the equivalent capacitance of the area.

More specifically, the complex impedances Zref (t) and Zcap (t) of the two RC circuits shown in FIG. 1 are determined as follows:

Z_{ref}(t)=1/(1/R_{ref}+1 ωC_{ref})

Z_{cap}(t)=1/(1/R_{caps}+1 ωC_{Cap})

We deduce from these relationships that when ω is “high” (i.e. the frequency of the alternating current voltage Vin (t) is very important):

C_{cap}=C_{ref}·V_{ref}/(V_{ref}) Sensor running on the capacitive model.

in such a way that knowledge of Vᵢₙ (t) and V_{ref} (t) permits to find the equivalent capacitance C_{cap} of the area formed by the fibers and the liquid resin: the sensor formed by the two electrodes 1 and 3 thus operates according to a capacitive mode.

In practice the steel moulds and the electronic environment of the sensor generate a parasitic capacitance which disturbs the measurement.

The C_{ref} capacitance should thus be modified according to a law of the type:

C_{ref}(modified)(t)=C_{ref}(t)+Cₚₐᵣₐₛᵢₜₑ (t)

This parasitic capacitance can be evaluated by filling the volume between the electrodes with a material whose capacitance is known, thus providing the evolution of Cₚₐᵣₐₛᵢₜₑ according to the variation of capacitance between the electrodes.

The other possibility is to perform a simultaneous measurement on both sides of the electrode by rearranging the electrodes and the reference. The ratio of these two voltages permits to eliminate the parasitic capacitance.

The last possibility is to maintain the guard electrode at the same potential as the sensor allowing at the same time for the suppression of edge effects but also the suppression of external interferences.

Conversely, when working with low w values, we deduce from preceding relationships:

R_{cap}=R_{ref.}((Vᵢₙ−V_{ref})/V_{ref}) Sensor running on the electrical conductivity model.

hence permitting to determine the equivalent resistance R_{cap} of the area formed by the liquid resin and the fibers: the sensor formed by the electrodes 1 and 3 then runs on the electrical conductivity model (it may then be wise to remove the reference capacitance which is no longer useful).

Thus, when working at high frequencies and analyzing the voltage Vref (t), information regarding the presence, number and shape of the bubbles present in the liquid resin just prior to polymerization can be accessed.

Depending on the results of this information, we can correct a number of parameters of the process such as the resin injection pressure, so as to try to reduce the bubbles in the resin, and thus avoid ending up in fine with a polymerized part having an inacceptable porosity.

More specifically, the equipment for analyzing the voltage V_{ref} (t) needs a signal processing equipment, which may comprise a signal conditioner, supplying an analog signal to a sample-and-hold circuit, which is in turn connected to an analog-to-digital converter.

The role of the sample-and-hold circuit is to collect instantaneous values and to maintain them at the input of the analog-to-digital converter during at least the time required for one conversion.

The sample-and-hold circuit and analog-to-digital converter can be controlled by a logic circuit which gives the order of sampling at the selected moments.

Such a logic function can be performed by a simple wired logic system or a microprocessor that provides the possibility to program the desired management.

The output of the analog-to-digital converter may be either processed by a computer (see the following regarding the rate of bubbles), or stored for later analysis, or even reconstituted in its original analog form by a digital-to-analog converter and used in controlling the process.

As shown in FIG. 2, there are of course edge effects 5, 7, at the periphery of the two electrodes 1 and 3, which might disrupt the reliability of the measurements.

This is why guard electrodes 9, 11 and 13, 15, are added at the periphery of the two electrodes 1 and 3, in such a way as to preserve the latter electrodes from edge effects, and thereby obtain reliable voltage measurements.

Results which are typically obtained with the previously described measuring device are shown in FIG. 4.

The abscissa of the graph of FIG. 4 represents the time, and the ordinate of this graph represents the value of the measured voltage V_{ref} (t).

The line F indicates the passage of the resin front to the right of the two electrodes 1 and 3.

As this chart illustrates, therefore, the voltage V_{ref} (t) rises sharply at the arrival of the resin front F, then continues to rise less significantly once this front is passed.

The dotted curve Vₘₐₓ represents the theoretical value of V_{ref} if the liquid resin flowing between the two electrodes 1 and 3 were completely devoid of bubbles: we see that in this hypothesis, the voltage V_{ref}(t) would reach a strictly flat level shortly after the passage of the resin front.

A first manner of determining the rate of bubbles in the resin is to operate the device described above, according to the capacitive mode, that is to say with high frequencies for the alternating current voltage Vᵢₙ(t) applied to the electrode 1.

By naming φᵥ, φᵣ, and φ_{f} the rates of bubble, resin and fibers between the two electrodes 1 and 3, we have the relationship φᵥ, +φᵣ, +φ_{f}=1.

By naming εᵥ, εᵣ, ε_{f}, and εₜ respectively the permittivity constants of vacuum, the resin, the fibers and the composite, we obtain a relationship of the type, φᵥ=f(εᵥ, εᵣ, ε_{f}, and εₜ, φ_{f}, C_{cap}), when the device operates in the capacitive mode.

We can hence deduce from this type of relationship the value of the rate of bubbles φᵥ.

Another way to determine this rate is to operate the measuring device described above in the resistive mode, that is to say with relatively low frequencies for the alternating current voltage Vᵢₙ (t).

In this particular mode of operation, it can be shown that there is a relationship of direct proportionality between the Vₘₐₓ and V_{ref} (t) values (see FIG. 4), the proportionality factor between these two values being representative of the liquid saturation S of the area disposed between the two electrodes 1 and 3.

As a result, the vacuum rate (rate of bubbles) can be expressed as (1−S)*100.

Thereafter, when we want to push further investigations especially in relation to the shape of bubbles, we process appropriately the signal representative of the capacitance C_{cap} of the area disposed between the two electrodes 1 and 3.

This signal includes, in fact, information relating to the permittivity of the different components of the area (fiber, resin, vacuum), this permittivity being a function of the volume rate of each of these components and of their shape (more precisely, the arrangement of the surfaces in contact between the components in the measured volume).

We can then deduce, from these permittivity variations and from the constitutive equations of the area formed by the resin, fibers and bubbles, shape factors which are representative of the geometry (cylindrical or spherical) of the bubbles.

As can be understood in view of the foregoing description, the method and the installation according to the present disclosure permit, in a very simple manner, to measure a number factors such as the presence, the rate and the shape of the bubbles located inside the liquid resin which will infuse through the fiber fabrics, just before the polymerization step.

We can deduce from these measurements coercive actions to be carried out in order to limit, or even reduce, the risk of getting in fine a porous composite part.

These measurements also permit to detect the end of the resin filling, which manifests when there are no longer bubbles in the resin.

Only one pair of electrodes 1, 3 has been shown in the context of the present description, but it must of course be understood that several pairs of electrodes can be arranged in several places of the mould and the counter-mould for making the composite part, in order to detect the presence of bubbles in different portions of the area formed by the liquid resin and the fibers.

What is claimed is:

1. A method of detecting bubbles during resin injection operations for a manufacture of fiber composite components, by means of an installation comprising:
at least one mould and one counter-mold;
at least one pair of electrodes respectively disposed in the mould and the counter-mould;
a source of alternating current input voltage (Vᵢₙ (t)) connected to one of the electrodes;
an RC circuit connected firstly to one of the electrodes and secondly to a mass (M), at an end of which is found an alternating current reference voltage (V_{ref}(t)); and
means for signal processing, adapted to exploit measurements of said alternating current input voltage and alternating current reference voltage,
wherein a rate of bubbles included between said electrodes is calculated from said measurements.

2. The method according to claim 1, wherein a relatively high frequency is used for said source of alternating current input voltage (Vᵢₙ (t)), and a capacitance (C_{cap}) of at least one portion of an area formed by fibers and liquid resin is measured, said rate of bubbles being deduced from a relationship of a type φᵥ=f (εᵥ, εᵣ, ε_{f}, and εₜ, φ_{f}, C_{cap}), where εᵥ, εᵣ, ε_{f}, and εₜ, are respectively permittivity constants of vacuum, the resin, the fibers and the fiber composite, and φᵥ, φᵣ, and φ_{f} are respectively the rate of bubbles, the resin and the fibers between the two electrodes.

3. The method according to claim 2, wherein said capacitance (C_{cap}) measurement is used to derive coefficients of depolarization of said bubbles, and thus shapes and sizes of the bubbles.

4. The method according to claim 1, wherein a relatively low frequency is used for said source of alternating current input voltage (Vᵢₙ (t)), said alternating current reference voltage (V_{ref} (t)) being compared to a voltage value (Vₘₐₓ) representing a theoretical value (V_{ref} (t)) if the resin flowing between said electrodes is totally free of bubbles, and said rate of bubbles is deduced from a proportionality factor between the two values.

5. The method according to claim 1, wherein guard electrodes are added at a periphery of said electrodes to preserve the electrodes from edge effects.

6. The method according to claim 2, wherein the area formed by the fibers and liquid resin is the RC circuit comprising a resistance (R_{cap}) and the capacitance (C_{cap}).
